(19) United States
(12) Patent Application Publication
(10) Pub. No.: US 2022/0172240 A1
(43) Pub. Date: Jun. 2, 2022

(54) INFORMATION PROCESSING DEVICE, METHOD, AND MEDIUM

(71) Applicant: Rakuten Group, Inc., Tokyo (JP)

(72) Inventor: Ai NAKAZAWA, Tokyo (JP)

(73) Assignee: Rakuten Group, Inc., Tokyo (JP)

(21) Appl. No.: 17/523,478

(22) Filed: Nov. 10, 2021

(30) Foreign Application Priority Data
Nov. 27, 2020 (JP) 2020-196581

(51) Int. Cl. G06Q 30/02; G06Q 30/06

(52) U.S. Cl. CPC G06Q 30/0208; G06Q 30/0635

(57) ABSTRACT

An object is to inhibit a workload in delivery or a store in a service in which a user orders a product through a terminal. An information processing device includes: a first order accepting unit configured to accept a first order from a user terminal; a user identifying unit configured to identify one or more second users associated with the first user relating to the first order in advance; a second order accepting unit configured to accept one or more second orders from the one or more second users within a predetermined period after the first order is accepted; and an order information associating unit configured to associate order information relating to the first order and order information relating to the second orders with each other in an order information bundle to be prepared together by a store relating to the orders.

### CROSS-REFERENCE TO RELATED APPLICATION(S)

This application claims priority to and the benefit of Japanese Patent Application No. 2020-196581, filed on Nov. 27, 2020, the disclosure of which is expressly incorporated herein by reference in its entirety for any purpose.

### FIELD

The present disclosure relates to a technology for enabling a user to order a product through a terminal.

### BACKGROUND

In the related art, a sales management device including: an order information receiving unit that receives order information, which includes information on a product purchased by a customer and a planned date and time of a visit of the customer to a store, from a user terminal of the customer; a preparation start instruction unit that instructs a store clerk to start preparation of products on the basis of the planned date and time of the visit; and a delivery product information notifying unit that notifies a customer of information about a product to be delivered in accordance with reception of an arrival notification indicating that the customer has arrived at the store, is proposed, in which, in a case in which an arrival notification has been received and preparation of two or more products including the above-described product that has been ordered by another customer is completed, the delivery product information notifying unit notifies of information about a product of which preparation has been completed first (see Japanese Patent Application Publication No. 2019-067048).

In addition, various technologies for enabling a user to order a product through a terminal such as a store sales system capable of sensing an approach of a user terminal of a product orderer, performing delivery preparation of products in accordance with a predicted visit time, and quickly providing the product at the time of the visit to the store and the like are proposed (see Japanese Patent Application Publication Nos. 2004-280468, 2018-101409, and 2019-185727).

### SUMMARY

In the related art, there are a service enabling a user to order a product through a terminal and receive delivery of the product at a designated place (hereinafter referred to as “delivery service”), a service enabling a user to order a product through a terminal and pick up the product at a store in person (hereinafter referred to as “advance-order takeout service”), and the like. However, in such services, delivery and pickup are performed for each user who has ordered, and thus a workload required for delivery and the store increase.

In view of the problems described above, an object of the present disclosure is to inhibit a workload required for delivery and a store in a service in which a user orders a product through a terminal.

An example of the present disclosure is an information processing device including: a first order accepting unit configured to accept a first order from a user terminal; a user identifying unit configured to identify one or more second users associated with the first user relating to the first order in advance; a second order accepting unit configured to accept one or more second orders from the one or more second users within a predetermined period after the first order is accepted; and an order information associating unit configured to associate order information relating to the first order and order information relating to the second orders with each other in an order information bundle to be prepared together by a store relating to the orders.

The present disclosure can be understood as an information processing device, a system, a method performed by a computer, or a program executed by a computer. In addition, the present disclosure can be understood as a recording medium on which such a program is recorded, that can be read by a computer, any other device, a machine, or the like. Here, the recording medium that can be read by a computer or the like represents a recording medium on which information such as data, a program, and the like are stored through an electrical, magnetic, optical, mechanical, or chemical reaction and can be read from a computer or the like.

According to the present disclosure, in a service in which a user orders a product through a terminal, a workload required for delivery and a store can be inhibited.

### BRIEF DESCRIPTION OF THE DRAWINGS

FIG. 1 is a diagram illustrating an outline of the hardware configuration of an information processing system according to an embodiment;

FIG. 2 is a diagram illustrating an outline of the functional configuration of an information processing system according to an embodiment;

FIG. 3 is a flowchart illustrating the flow of a store/product information providing process according to an embodiment;

FIG. 4 is a flowchart (A) illustrating the flow of an order management process according to an embodiment; and

FIG. 5 is a flowchart (B) illustrating the flow of an order management process according to an embodiment.

### DESCRIPTION OF EMBODIMENTS

Hereinafter, an information processing device, a method, and a program according to an embodiment of the present disclosure will be described with reference to the figures. The embodiment described below is an example of an embodiment, and an information processing device, a method, and a program according to the present disclosure are not limited to specific configurations described below. In implementation, a specific configuration according to an aspect of the implementation may be appropriately employed, and various improvements and modifications may be made.

In this embodiment, a form of implementation of a case in which a technology according to the present disclosure is applied to a system in which, when a certain user uses an advance-order takeout service, in a case in which “sharing order” is called to other users and there is a sharing order from another user, a product ordered by the corresponding user and a product ordered by the other user can be received together at a store will be described. In this embodiment, although there are individual orders made by a plurality of users, orders for which reception (pickup, delivery, or the like) of the products that is performed together will be referred to as a sharing order. The technology according to the present disclosure can be widely used in technologies enabling sharing orders, and an application target of the present disclosure is not limited to the example illustrated in the embodiment. For example, the technology according to the present disclosure may be applied to a system used for a delivery service.

### Configuration of System

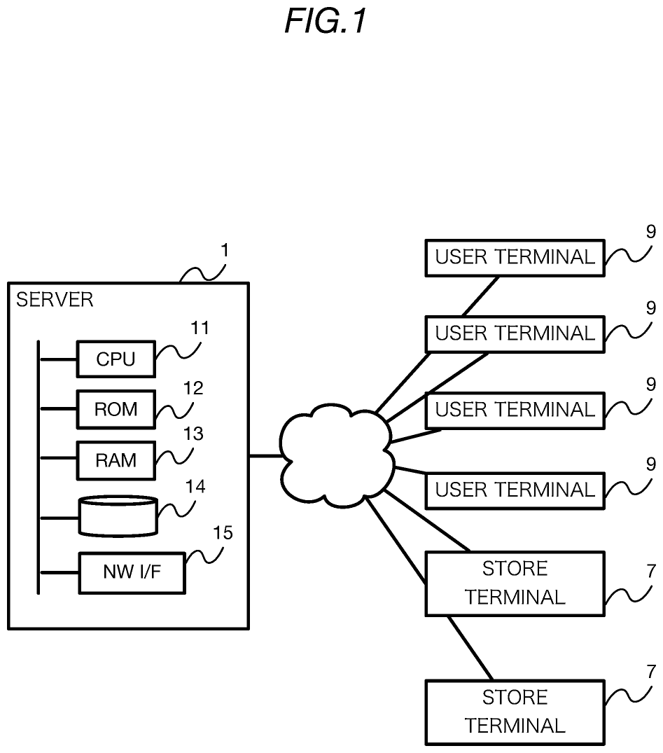

FIG. 1 is a diagram illustrating an outline of the hardware configuration of a system according to this embodiment. The system according to this embodiment includes a server 1, one or a plurality of user terminals 9, and one or a plurality of store terminals 7 that are able to communicate with each other by being connected to a network.

The server 1 is a server used for realizing a sharing order by accepting order information from each of the plurality of user terminals 9, gathering a plurality of pieces of order information satisfying a predetermined condition in the accepted order information, and transmitting the plurality of pieces of order information to the store terminal 7 as one order information bundle. The server 1 is a computer that includes a central processing unit (CPU) 11, a read only memory (ROM) 12, a random access memory (RAM) 13, a storage device 14 such as an electrically erasable and programmable read only memory (EEPROM) or a hard disk drive (HDD), a communication unit 15 such as a network interface card (NIC), and the like. Here, for a specific hardware configuration of the server 1, omissions, substitutions, and additions may be appropriately performed in accordance with the aspect of implementation. In addition, the server 1 is not limited to a device that is formed from a single casing. The server 1 may be realized by a plurality of devices using technologies of so-called cloud, distributed computing, and the like.

The user terminal 9 is a terminal device that is used by a user. The user terminal 9 is a computer that includes a CPU, a ROM, a RAM, a storage device, a communication unit, an input device, an output device, and the like (not illustrated). In addition, the user terminal 9 is not limited to a device that is formed from a single casing. The user terminal 9 may be realized by a plurality of devices using technologies of so-called cloud, distributed computing, and the like. A user can use various services provided by the server 1 through such a user terminal 9.

The store terminal 7 is a terminal device that is used by a store clerk at a store. The store terminal 7 is a computer that includes a CPU, a ROM, a RAM, a storage device, a communication unit, an input device, an output device, and the like (not illustrated). In addition, the store terminal 7 is not limited to a device that is formed from a single casing. The store terminal 7 may be realized by a plurality of devices using technologies of so-called cloud, distributed computing, and the like. A store clerk uses various services provided by the server 1 through such a store terminal 7.

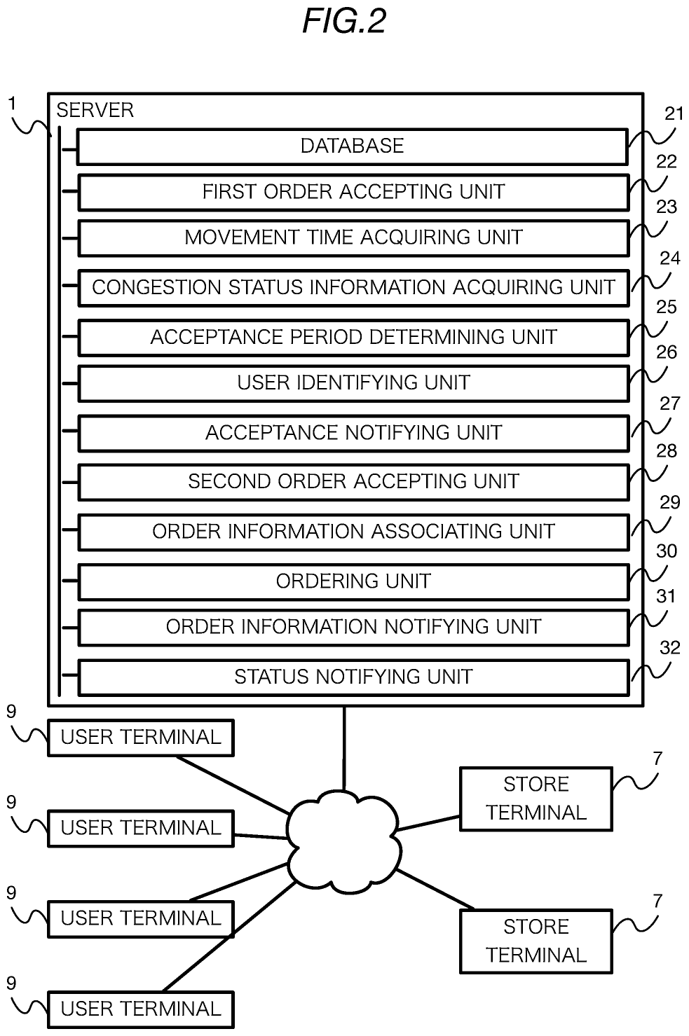

FIG. 2 is a diagram illustrating an outline of the functional configuration of the information processing system according to this embodiment. Each hardware component included in the server 1 is controlled by a program recorded in the storage device 14 being read into the RAM 13 and executed by the CPU 11, whereby the server 1 functions as an information processing device that includes a database 21, a first order accepting unit 22, a movement time acquiring unit 23, a congestion status information acquiring unit 24, an acceptance period determining unit 25, a user identifying unit 26, an acceptance notifying unit 27, a second order accepting unit 28, an order information associating unit 29, an ordering unit 30, an order information notifying unit 31, and a status notifying unit 32. Although each of the functions of the server 1 is executed by the CPU 11 that is a general-purpose processor in this embodiment and other embodiments to be described below, some or all of such functions may be executed by one or a plurality of dedicated processors.

The database 21 is a database that is used for accumulating and managing various kinds of information including store information, user information, and order information that are used in the system disclosed in this embodiment. Here, the store information is information that includes a store ID, location information, product information, congestion status information and the like and is associated with a store in which an advance-order takeout service can be used. The user information includes a user ID, an address (a mail address or an IP address), settlement information, and a group ID of a group to which a corresponding user belongs and is information associated with the user using this system. In addition, the order information includes information of an order ID, a user ID, a store ID, product information, a price, a quantity, a planned pickup time, a drop place of a sharing order product, and the like and is information representing details of an order made by a user.

The first order accepting unit 22 accepts a first order from the user terminal 9. A user relating to the corresponding order becomes a host (a first user) of a sharing order.

The movement time acquiring unit 23 acquires a movement time required for a user (first user) relating to a first order to arrive at a store. More specifically, the movement time acquiring unit 23 acquires a movement time, which is calculated on the basis of location information of a first user and location information of a store, required for the first user to arrive at the store. For calculation of the movement time, the related art for calculating a movement time between two places using map information and traffic information may be used, and thus description thereof will be omitted.

The congestion status information acquiring unit 24 acquires congestion status information of a store from the store terminal 7 of the store relating to the first order. By acquiring the congestion status information of a store, the acceptance period determining unit 25 to be described below can determine an acceptance period of a second order (sharing order) with the current congestion status taken into account together with a preparation time required until products and the like become able to be received. In addition, the congestion status information acquiring unit 24 may acquire congestion status information for each time frame during business hours from a store in advance and store the acquired congestion status information in association with a store ID. For example, in a case in which the congestion status information for each time frame is acquired from a store with 24-hour business in advance, rankings such as a degree of congestion from 0:00 to 6:00 of “1”, a degree of congestion from 6:00 to 9:00 of “3”, a degree of congestion from 9:00 to 12:00 of “2”, and a degree of congestion from 12:00 to 13:00 of “5” can be acquired. With this configuration, congestion status information prepared in advance for each time frame can be used without requesting an operation of notifying of a congestion status from the stores.

In a case in which a first order has been accepted, the acceptance period determining unit 25 determines an acceptance period for the first order in which a second order (a sharing order) can be received. Here, the acceptance period determining unit 25 determines an acceptance period on the basis of at least one of (1) a plan designated by a first user or a store, (2) a movement time acquired by the movement time acquiring unit 23, (3) a standard preparation time until preparation of a product included in a first order is completed, and (4) the congestion status information acquired by the congestion status information acquiring unit 24.

More specifically, the acceptance period determining unit 25 calculates a planned pickup time on the basis of (1) and/or (2) described above, further calculates a preparation time of products on the basis of (3) and/or (4) described above, and determines a time calculated as “planned pickup time—preparation time of products” as an acceptance period of the sharing order.

Here, as the planned pickup time, any one of a timing (“after n minutes”, “hh:mm a.m./p.m.”, or the like) designated by a first user or a store and a movement time acquired by the movement time acquiring unit 23 may be used. In addition, as the preparation time of products, a value acquired by performing a weighting/increasing or decreasing process based on the congestion status information acquired by the congestion status information acquiring unit 24 on a standard preparation time for each store or each product registered in the database 21 in advance may be used. Here, the congestion status of a store may be represented as a ranking using “high/intermediate/low” or a numerical value, and the weighting/increasing or decreasing process based on such congestion status information may be determined in advance for each store such as high (a waiting time of 20 minutes or more), intermediate (a waiting time of less than 20 minutes and more than 0 minutes), and low (a waiting time of 0 minutes) and may be calculated as high (the standard preparation time×2.0), intermediate (the standard preparation time×1.5), and low (the standard preparation time×1.0) or high (the standard preparation time+30 minutes), intermediate (the standard preparation time+10 minutes), and low (the standard preparation time+0 minutes).

Although an example in which a time from a timing at which a first order is made is used as an acceptance period is described in this embodiment, the acceptance period may be represented not by a time but by a close time of acceptance. Here, the close time may be calculated on the basis of an order time of the first user.

The user identifying unit 26 identifies one or more second users associated with the first user in advance. At this time, the user identifying unit 26 may identify another user belonging to the same group as the first user as a second user or may identify another user designated in advance by the first user as a second user. In a case in which identifying of a second user is performed on the basis of a group, groups may be formed on the basis of a predetermined rule. For example, a group may be formed on the basis of a criterion such as the same company, the same office, the same floor, or the same team. By forming groups in this way, for example, it is convenient to use the system according to this embodiment for an order of meals at lunch time. For forming groups, a method of transmitting an invitation link to a predetermined user and adding a user who has performed an approval operation on the page of a link destination, a method of accepting a participation request for a group from a user and adding a user whose request has been approved, or the like may be used.

After a first order is accepted, the acceptance notifying unit 27 notifies a second user identified by the user identifying unit 26 of acceptance of a second order (sharing order).

After the first order has been accepted, the second order accepting unit 28 accepts one or more second orders (sharing orders) from one or more second users within a predetermined period. Although the second order accepting unit 28 accepts a second order in an acceptance period determined by the acceptance period determining unit 25 in this embodiment, a period in which a second order can be accepted is not limited to the example of this embodiment. For example, a period in which a second order can be accepted may be a period that is set in advance before the first order.

The order information associating unit 29 associates order information relating to a first order and order information relating to a second order (a sharing order) with each other and sets resultant information as an order information bundle to be prepared together by a store relating to the orders.

The ordering unit 30 transmits an order relating to the order information bundle to the store as an order relating to one pickup.

The order information notifying unit 31 notifies the first user of the order information relating to the second order (a sharing order) that has been accepted by the second order accepting unit 28.

The status notifying unit 32 notifies a second user of a status relating to pickup and/or drop of a product that are performed by the first user.

### Flow of Process

Next, the flow of the process performed by the information processing system according to this embodiment will be described. Specific details and a processing sequence of the process described below are examples for performing the present disclosure. Specific process details and the processing sequence may be appropriately selected in accordance with an embodiment of the present disclosure.

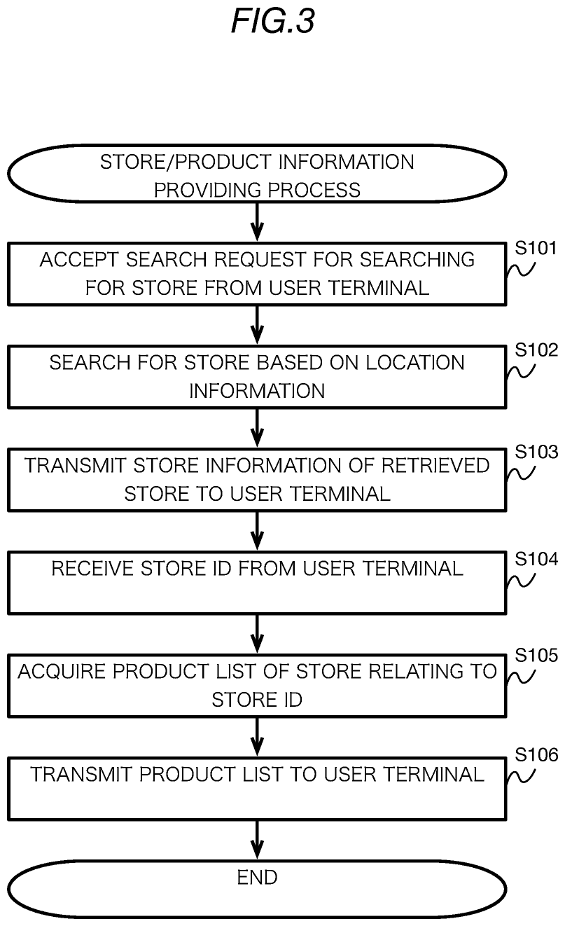

FIG. 3 is a flowchart illustrating the flow of a store/product information providing process according to this embodiment. Processes illustrated in this flowchart are performed with reception of a search request transmitted by the user terminal 9 as a trigger.

The user terminal 9 is connected to the server 1 via a network in accordance with a user operation and performs a search request for stores at which an advance-order takeout service can be used. At this time, the user terminal 9 according to this embodiment acquires current location information using a Global Positioning System (GPS) unit (not illustrated) built into the user terminal 9 or the like and transmits the current location information to the server 1. The location information of a user may be acquired by a unit other than a GPS unit (for example, a method using information acquired from a wireless LAN access point or a mobile phone network base station or the like). The server 1 that has accepted the search request (Step S101) searches for stores that can be used by a user from the database 21 on the basis of the location information acquired from the user terminal 9 and the like (Step S102).

In this embodiment, the server 1 searches for stores present within a predetermined range from the current location of a user on the basis of the location information acquired from the user terminal 9 and individual store location information stored in the database 21. The method for searching for stores that can be used by a user is not limited to the example illustrated in this embodiment. For example, stores that can be used may be acquired from a list generated in advance for each user or each group to which a user belongs. In addition, stores that can be used may be extracted on the basis of a category (for example, Japanese foods, a cafe, or the like) designated in advance by a user or a group to which the user belongs. For example, on the basis of location information and a designated category acquired from the user terminal 9 and the individual store location information and categories set for respective stores stored in the database 21, the server 1 searches for stores within a predetermined range from the current location of a user and of which categories coincide with or are close to the designated category. When stores that can be used by the user are retrieved, the server 1 transmits store information of stores included in a search result to the user terminal 9 and causes the user terminal 9 to display the store information (Step S103). At this time, the user terminal 9 may display the search result in the form of a list or on a map. The user selects a store from which he desires to receive a product from the search result displayed on the user terminal 9.

When the store is selected by the user, the user terminal 9 notifies the server 1 of a store ID of the store selected by the user. When a notification from the user terminal 9 is received (Step S104), the server 1 acquires a product list of products that can be ordered at the store selected by the user from the database 21 (Step S105) and transmits the product list to the user terminal 9 (Step S106). Thereafter, the process illustrated in this flowchart ends.

The user terminal 9 that has received the product list from the server 1 in the store/product information providing process described with reference to FIG. 3 displays the received product list and accepts selection of a product from the user. The user selects a product that he desires to order from the displayed product list, designates the quantity of the product, and inputs an order instruction. At this time, the user is able to input a planned pickup time. Here, the planned pickup time is a time acquired by designating a time at which the user desires to pick up the product in the form of “in XX minutes” or a time.

Furthermore, at this time, in a case in which a sharing order may be accepted for a corresponding order, the user inputs a drop place of a product relating to the sharing order that has been picked up (a place to which a product of the second user who has performed the sharing order is delivered). When information used for an order and an order instruction are input by a user, the user terminal 9 generates order information on the basis of the information input by the user and transmits the generated order information to the server 1. Here, the order information includes information such as a user ID, a store ID, product information, a price, a quantity, a planned pickup time, and a drop place of a sharing order product.

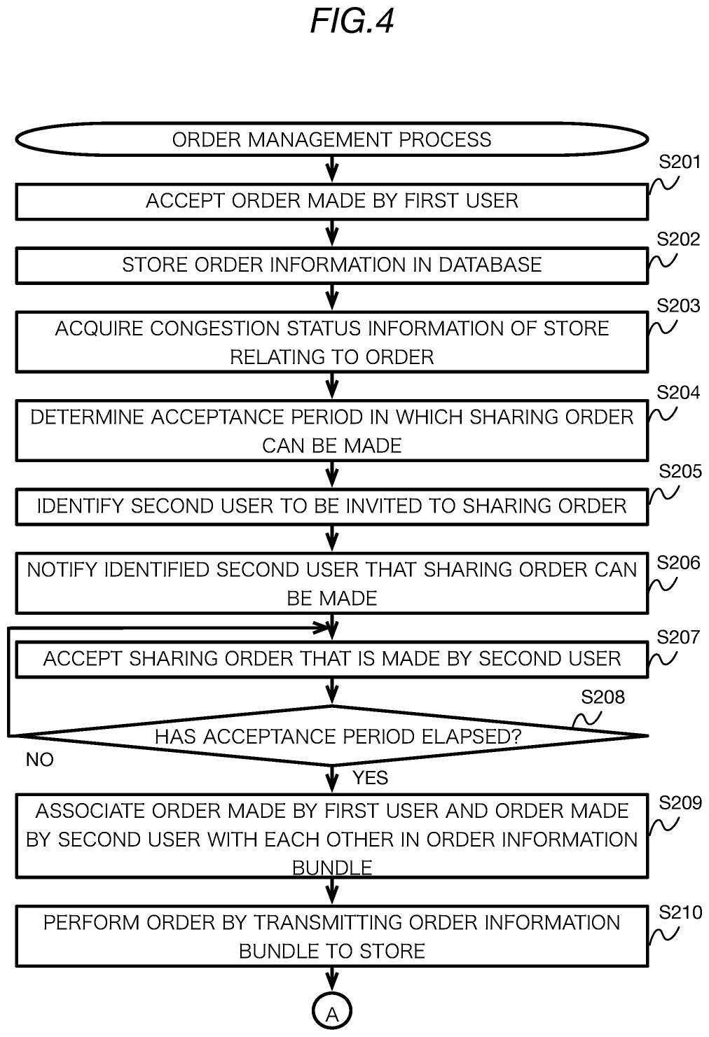

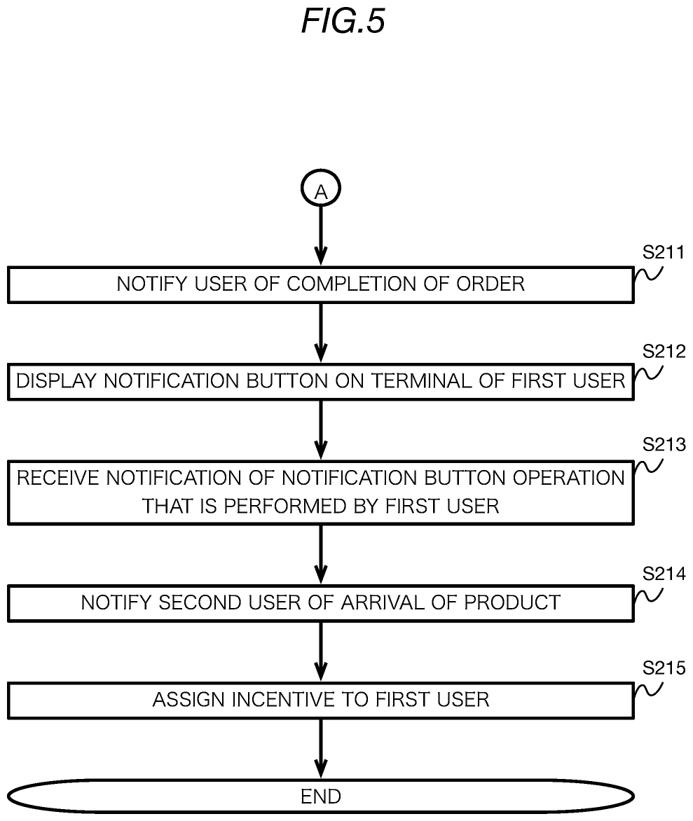

FIGS. 4 and 5 represent a flowchart illustrating the flow of an order management process according to this embodiment. Processes illustrated in this flowchart are performed with reception of order information transmitted by the user terminal 9 as a trigger.

In Steps S201 and S202, an order made by a user who becomes a host of a sharing order (first user) is accepted. The first order accepting unit 22 receives order information transmitted from the user terminal 9 and communicates with the user terminal 9, thereby accepting an order of a product made by the user (Step S201). In this embodiment, together with acceptance of an order, payment relating to the order is processed on the basis of settlement information (credit card information, point information, or the like) of the corresponding user that is received from the user terminal 9 or is included in the user information. By causing the payment process to be completed at a time point of acceptance of an order, a user can omit payment at the store when the product is picked up. The related art may be used for the payment process, and thus a detailed description of the payment process will be omitted. The server 1 that has accepted an order assigns an order ID to the corresponding order information and stores the order information including information such as the order ID, a user ID, a store ID, product information, a price, a quantity, a planned pickup time, and a drop place of a sharing order product in the database 21 (Step S202). Thereafter, the process proceeds to Step S203.

In Steps S203 and S204, an acceptance period of a sharing order is determined. The congestion status information acquiring unit 24 acquires congestion status information of a store associated with the store ID represented in the order information received in Step S201 (Step S203). The congestion status information acquired here may be information of which a store notifies the server 1 in advance and that represents the current congestion status of the corresponding store stored in association with the store ID by the server 1 or may be congestion status information that is acquired from the store terminal 7 by the server 1 inquiring of the store terminal 7 at a timing of the corresponding order. The acceptance period determining unit 25 determines an acceptance period in which a sharing order for an order relating to the order information received in Step S201 can be made (Step S204). Thereafter, the process proceeds to Step S205.

In Steps S205 and S206, acceptance of a sharing order starts. On the basis of a user ID represented in the order information received in Step S201, the user identifying unit 26 identifies a user (second user) to be invited to a sharing order having the corresponding user as a host (first user) (Step S205). The identifying of the second user can be performed using various methods. For example, the user identifying unit 26 can identify a second user from a list designated in advance by the first user. In addition, for example, the user identifying unit 26 can identify another user belonging to a group to which the first user belongs. For grouping, a method in which a group ID of a group to which a corresponding user belongs is recorded in the user information and/or a method in which a user ID of a user belonging to a group is recorded in a member list of the group and the like may be employed.

When a second user who can perform a sharing order is identified, the acceptance notifying unit 27 acquires an address of the identified second user from the database 21 and sends a notification that acceptance of a sharing order can be performed to the acquired address (a sharing order proposal; Step S206). More specifically, the acceptance notifying unit 27 transmits an electronic mail in a case in which the address is an electronic mail address and transmits a push notification to an application operating in the user terminal and the like in a case in which the address is an address such as an IP address from which the user terminal can be identified. The notification includes an order ID of a first order, a user ID of the first user, a store in which a sharing order can be performed (more specifically, a store relating to an order of the first user), an acceptance period of the sharing order, a drop place of a sharing order product, and the like. In addition, product information of the order of the first user and the like may be further included in the notification. The user terminal 9 of the second user that has received the notification displays a product list of products that can be ordered in addition to information provided from the server 1, that is, the store in which a sharing order can be performed, an acceptance period of the sharing order, a drop place of a sharing order product, and the like together with an indication that the sharing order can be performed. Thereafter, the process proceeds to Step S207.

In Steps S207 and S208, a sharing order performed by a user, who has received a sharing order availability notification, can be accepted within an acceptance period of the sharing order. Until the acceptance period of the sharing order calculated in Step S204 elapses (Step S208), the second order accepting unit 28 accepts a second order (a sharing order) from the user terminal 9 that has received the sharing order availability notification (Step S207). Until the acceptance period of the sharing order calculated in Step S204 elapses, the second order accepting unit 28 can accept a plurality of different orders from a plurality of different users. In addition, until the acceptance period of the sharing order elapses, the order information notifying unit 31 may sequentially notify the user terminal 9 of the first user of participation of another user, a status of the sharing order, and the like and cause the user terminal 9 of the first user to display them.

In addition, a restriction other than the acceptance period may be set on the acceptance of the sharing order. For example, there is a limit on the quantity of products that can be picked up by a host (a first user), and thus there may be a restriction on the number of users who can perform sharing orders, the number of products that can be included in one order information bundle, or the like in accordance with a type of store or product.

In a case in which the second user who has received a notification from the acceptance notifying unit 27 desires to perform a sharing order, the second user can order a product from the server 1 using his own terminal within the acceptance period of the sharing order. More specifically, the second user who has received a notification selects a product that he desires to order from a product list of products that can be ordered at a store relating to the notification and designates the quantity of the product, thereby inputting an order instruction. When information used for the second user to perform an order is input, the user terminal 9 of the second user generates second order information on the basis of information input by the second user and transmits the generated second order information to the server 1. Here, the second order information includes information such as an order ID of the first order performed by the first user, a user ID of the second user, a store ID, product information, a price, a quantity, and the like.

In this embodiment, an example in which an order ID of a first order is used as information used for identifying whether or not an order is a sharing order relating to the first order will be described. However, any other information such as a user ID of a first user or the like may be used as information used for identifying whether an order is a sharing order relating to a certain first order. Accepting of the second order information by the server 1 and the user terminal 9 communicating with each other and processing of payment relating to a corresponding sharing order at this time point are mostly the same as the details described in Step S201, and thus description thereof will be omitted. By completing the payment process at the time point of order acceptance, settlement between a first user (host) and a second user (sharing user) can be omitted. Thereafter, the process proceeds to Step S209.

In Steps S209 to S210, an order process relating to a sharing order is performed. By associating the first order information accepted from the first user in Step S201 and the second order information accepted in Step S208 with each other, the order information associating unit 29 sets such a plurality of pieces of order information as one order information bundle (Step S209). Then, the ordering unit 30 transmits the plurality of pieces of order information associated in Step S209 to the store terminal 7 as one order information bundle (Step S210). The store checks orders included in the order information bundle accepted by the store terminal 7, prepares products within a planned pickup time included in the order information bundle, and waits for the first user to pick up the products. Thereafter, the process proceeds to Step S211.

In Steps S211 to S214, the status of pickup of the products is updated and notified of. When the order of the products is completed, the order information notifying unit 31 notifies the user terminal 9 of the first user of the second order information accepted in Step S208 and completion of the order at the store (Step S211). With this configuration, in a case in which there is a sharing order, the first user can find out which products he should pick up. The first user may be notified of details of a sharing order every time a sharing order is accepted in Step S208. The first user picks up the products that he has ordered and products relating to a sharing order at the store at which the first user has performed the order within a planned pickup time.

In a case in which a notification indicating that preparation of the products has been completed (the products can be picked up) is received from the store terminal 7, or the planned pickup time has elapsed, the server 1 causes the user terminal 9 of the first user to display a button (for example, an “I'm Back” button or the like) that is operated in a case in which the first user who has picked up the products arrives at a distribution place and drops (delivers) the products (Step S212). When the first user who has dropped the products picked up at the store operates the corresponding button, the user terminal 9 notifies the server 1 that the corresponding button has been operated, and the status notifying unit 32 of the server 1 that has received the corresponding notification (Step S213) notifies the user terminal 9 of the second user, who has performed the sharing order, of the products having been dropped at the distribution place designated in advance (Step S214). Thereafter, the process proceeds to Step S215.

In Step S215, an incentive is assigned to the first user. The server 1 assigns an incentive such as points or a coupon to the first user who has completed the role of the host of a sharing order and stores the incentive in the database in association with the user ID. At this time, the quantity of the incentive that the first user can receive in accordance with points or a coupon may change in accordance with the magnitude of responsibility or a load of the host undertaken for this sharing order. For example, the server 1 may calculate the quantity of the incentive assigned to the first user using a calculation method for calculating “the number of users performing sharing orders x predetermined points”, “the quantity of products ordered as sharing orders x predetermined points”, or “the amount of money of the sharing order x predetermined ratio”. Thereafter, the process illustrated in this flowchart ends.

Conventionally, in an advance-order takeout service, for example, even in a case in which a certain user and a plurality of users working at the same company as that of the user order at the same store in the same time frame (timing), they individually need to go to the store to pick up products, which causes congestion in the store. In addition, in accordance with each user individually ordering at the store, a communication load between the store and the server increases.

However, according to the system of the embodiment described above, the first user serves as a host and goes to the store to pick up products for sharing orders, and thus the congestion of the store can be alleviated. In addition, according to the system of this embodiment, a period in which other users can make sharing orders is controlled with a preparation time of products, a movement time of a user who has made the order at a store, a congestion status of the store, and the like being taken into account, and thus a communication load between the server 1, the terminal, and the store can decrease. Furthermore, settlement of payment is performed between a store and each user, and thus a pickup operation of the first user (host) does not become complicated.

### Variation

Although an example in which the technology relating to the present disclosure is applied to a system used for an advance-order takeout service has been described in the embodiment described above, the technology relating to the present disclosure can be widely used for technologies enabling a sharing order, and the application target of the present disclosure is not limited to the advance-order takeout service. For example, the technology relating to the present disclosure may be applied to a system used for a delivery service.

In a case in which the technology relating to the present disclosure is applied to a system used for a delivery service, a process for pickup/drop that is performed by the first user is substituted with a process for delivery performed by a delivery person among the specific processing details described above. More specifically, for example, the movement time acquiring unit 23 acquires a movement time required for a delivery person to arrive at a store, and the acceptance period determining unit 25 determines an acceptance period on the basis of “(1b) a plan designated by a delivery person or a store” in place of “(1) a plan designated by a first user or a store”. In addition, the order information notifying unit 31 notifies the delivery person of order information, and the status notifying unit 32 notifies the first user and the second user of statuses relating to pickup and/or drop of products performed by the delivery person. Furthermore, in the process described using flowcharts illustrated in FIGS. 4 and 5, for example, a button operated in a case in which a delivery person who has picked up products arrives at a distribution place (see Step S212) is displayed on a terminal of the delivery person and is operated by the delivery person. In addition, various changes may be employed for applying the technology relating to the present disclosure to a delivery service.

The server 1 may provide a use status of a sharing order service according to a group to which a user belongs for a user terminal of the corresponding user, and the use status may be configured to be readable for the user through an application used for the service according to the present disclosure operating in the user terminal. In addition, by assigning an incentive according to the use status of a second user or the use status of a group also to the second user participating in a sharing order, the server 1 may promote the use of the service.

In addition, appearance information (a portrait or the like) of a person visiting a store for pickup (the first user in the case of an advance-order takeout service and a delivery person in the case of a delivery service) that is acquired from a database may be included in order information transmitted from the server 1 to the store. In this way, a store can easily recognize a user visiting the store for pickup. A user determination method used at a store may be a method in which an ID presented by a user (which may be presented by a physical medium or may be electronically presented) is read from the store side or the like.

Furthermore, although settlement of payment is performed between a store and each user in the embodiment described above, instead of this method, a method in which the first user representatively pays fares for all the orders and collects a fare corresponding to a second user from the corresponding second user at an arbitrary timing before or after pickup may be used. In addition, adjustment between the first user and the second user at this time may also be processed using a payment method for each user registered in the server 1.

What is claimed is:

1. An information processing device comprising:
a memory; and
a processor coupled to the memory, the processor being configured to execute:
accepting a first order from a user terminal;
identifying one or more second users associated with the first user relating to the first order in advance;
accepting one or more second orders from the one or more second users within a predetermined period after the first order is accepted; and
associating order information relating to the first order and order information relating to the second orders with each other in an order information bundle to be prepared together by a store relating to the orders.

2. The information processing device according to claim 1, the processor further executes determining an acceptance period in which the second orders relating to the first order are able to be accepted in a case in which the first order has been accepted,
wherein the processor accepts the second orders in the acceptance period.

3. The information processing device according to claim 2, the processor further executes acquiring a movement time required for the first user to arrive at the store,
wherein the processor determines the acceptance period on the basis of at least the movement time.

4. The information processing device according to claim 2, wherein the processor determines the acceptance period on the basis of at least a preparation time until preparation of a product included in the first order is completed.

5. The information processing device according to claim 4, the processor further executes acquiring congestion status information of a store from a store terminal of the store relating to the first order,
wherein the processor determines the acceptance period on the basis of at least the preparation time and the congestion status information.

6. The information processing device according to claim 2, wherein the processor determines the acceptance period on the basis of a plan designated by the first user or the store.

7. The information processing device according to claim 1, the processor further executes notifying the second users identified by the processor of acceptance of the second order after the first order is accepted.

8. The information processing device according to claim 1, wherein the processor identifies, as the second user, another user belonging to the same group as the first user.

9. The information processing device according to claim 1, wherein the processor identifies, as the second users, another user designated by the first user in advance.

10. The information processing device according to claim 1, the processor further executes notifying the first user of order information relating to the second orders accepted by the processor.

11. The information processing device according to claim 1, the processor further executes notifying the second users of a status relating to pickup and/or drop of products that is performed by the first user.

12. The information processing device according to claim 1, the processor further executes transmitting, as one order, an order relating to the order information bundle to the store.

13. A method executed by a computer, the method comprising:
accepting a first order from a user terminal;
identifying one or more second users associated with a first user relating to the first order in advance;
accepting one or more second orders from the one or more second users within a predetermined period after the first order is accepted; and
associating order information relating to the first order and order information relating to the second orders with each other in an order information bundle to be prepared together by a store relating to the orders.

14. A non-transitory computer-readable recording medium having recorded thereon a program for causing a computer to execute:
accepting a first order from a user terminal;
identifying one or more second users associated with a first user relating to the first order in advance;
accepting one or more second orders from the one or more second users within a predetermined period after the first order is accepted; and
associating order information relating to the first order and order information relating to the second orders with each other in an order information bundle to be prepared together by a store relating to the orders.
